(19) United States
(12) Patent Application Publication
(10) Pub. No.: US 2004/0130074 A1
(43) Pub. Date: Jul. 8, 2004

(54) Method for blow molding a container with a handle part

(76) Inventor: Ming-Chieh Yu, Tao-Yuan Hsien (TW)

Correspondence Address: BANNER & WITCOFF, 1001 G STREET N W, SUITE 1100, WASHINGTON, DC, 20001, US

(21) Appl. No.: 10/390,030

(22) Filed: Mar. 18, 2003

(30) Foreign Application Priority Data
Jan. 2, 2003 (TW) 092100025

(51) Int. Cl. B29C 49/00

(52) U.S. Cl. 264/523; 264/334

(57) ABSTRACT

A method for blow molding a container having a container body and a handle part includes the steps of: preparing a mold including a bottom mold part having a bottom cavity and a receiving space, and an upper mold part having an upper cavity corresponding to the bottom cavity; placing the handle part into the receiving space; placing a container preform into the bottom cavity; through the upper mold part, closing the bottom mold part so that the upper cavity cooperates with the bottom cavity to define a mold cavity for blow molding the container body; and blow molding the container preform into the container body in a manner to integrate the container body with the handle part to result in the container.

### CROSS-REFERENCE TO RELATED APPLICATION

This application claims priority of Taiwanese application No. 092100025, filed on Jan. 2, 2003.

### BACKGROUND OF THE INVENTION

1. Field of the Invention

The invention relates to a method for blow molding a container, more particularly to a method for blow molding a container having a bottle body and a handle part, which are integrated with each other during a blow molding step.

2. Description of the Related Art

Referring to FIG. 1, a conventional container 10 is shown to include a container body 11 and a handle part 12.

Referring to FIG. 2, a method for making the container 10 includes a step of blow molding a preform 110 in a blow mold 20 to form the container body 11 having a bottom portion 111, a neck portion 112 opposite to the bottom portion 111, and two parallel annular recesses 113 between the bottom portion 111 and the neck portion 112.

Referring to FIG. 3, the container body 11 is then moved into a receiving portion 211 of a handle forming mold 21, and the handle forming mold 21 is closed thereafter. A molten resin is injected into the handle forming mold 21 through an injecting unit 22 to fill a space confined between the annular recesses 113 and the handle forming mold 21, and a handle forming cavity 212 so as to form the handle part 12 having two anchoring rings 13 anchored in the annular recesses 113, respectively (best shown in FIG. 1).

Although the aforesaid method can produce the container 10 having a handle part 12, it has the following shortcomings:

1. Since the conventional method includes two separate molding steps, the production efficiency is relatively low.

2. The molten resin is liable to enter into the gaps between the receiving portion 211 and the container body 11, in turn forming burrs on the container product 10. Therefore, the quality of the container 10 is relatively difficult to control.

### SUMMARY OF THE INVENTION

Therefore, the object of the present invention is to provide a method for blow molding a container, which is relatively efficient, and which enhances the quality of the container product.

The method for blow molding a container having a container body and a handle part according to this invention includes the steps of: preparing a mold that includes a bottom mold part having a bottom cavity and a receiving space for receiving the handle part, and an upper mold part having an upper cavity corresponding to the bottom cavity of the bottom mold part; placing the handle part into the receiving space of the bottom mold part of the mold; placing a container preform into the bottom cavity of the bottom mold part of the mold; through the upper mold part, closing the bottom mold part so that the upper cavity of the upper mold part cooperates with the bottom cavity of the bottom mold part to define a mold cavity for blow molding the container; and blow molding the container preform into the container body in a manner to integrate the container body with the handle part to result in the container.

### BRIEF DESCRIPTION OF THE DRAWINGS

Other features and advantages of the present invention will become apparent in the following detailed description of the preferred embodiment with reference to the accompanying drawings, of which:

FIG. 1 is a partly sectional view of a conventional container;

FIGS. 2 and 3 are sectional views illustrating a conventional method to make the conventional container of FIG. 1;

FIG. 4 is a flow diagram of a preferred embodiment of a method for making a container according to this invention;

FIG. 5 is a fragmentary schematic perspective view of a bottom mold part of a mold used for the preferred embodiment of the method for making a container according to this invention;

FIG. 6 is a fragmentary schematic perspective view showing a state in which a handle part is placed into a receiving space of the bottom mold part of the mold;

FIG. 7 is a schematic view showing a state in which a container preform is placed into the bottom mold part of the mold;

FIG. 8 is a schematic view showing a state in which a container body is formed from the container preform; and

FIG. 9 is an enlarged fragmentary sectional view of a container made by the preferred embodiment of the method according to this invention.

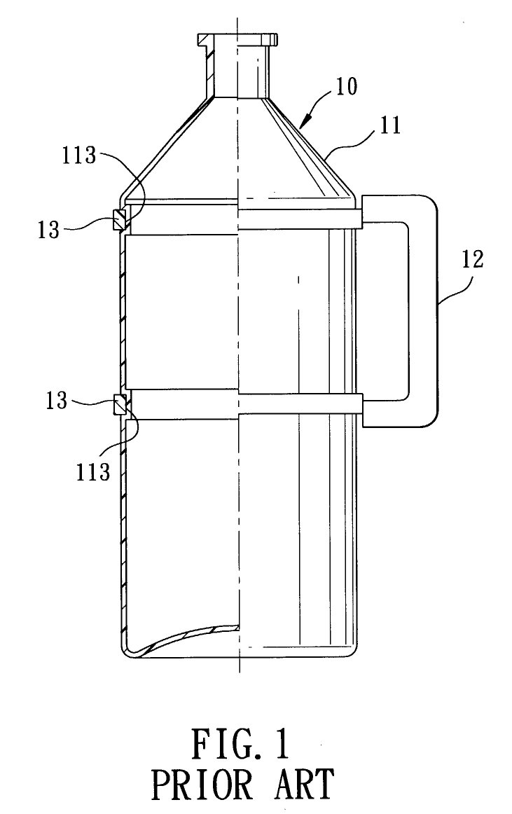

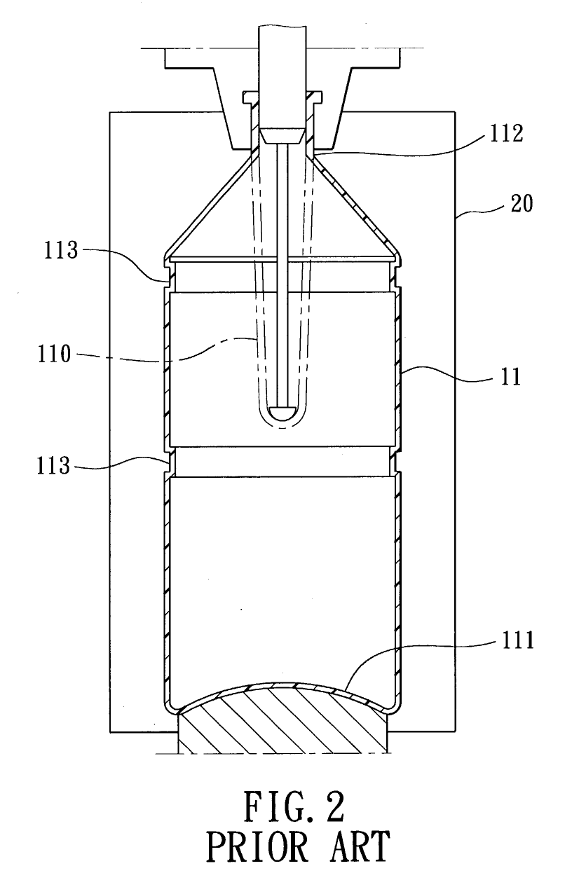

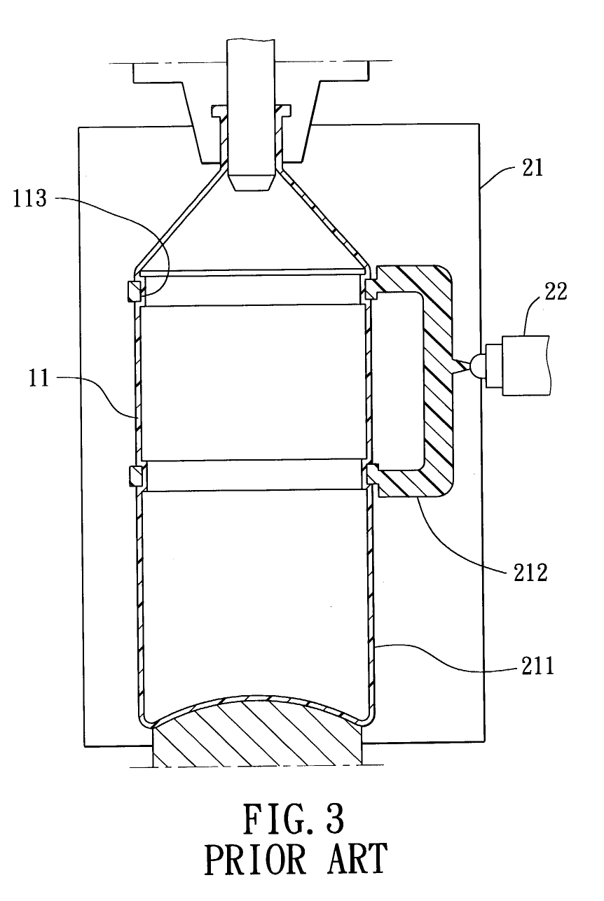

### DETAILED DESCRIPTION OF THE PREFERRED EMBODIMENTS

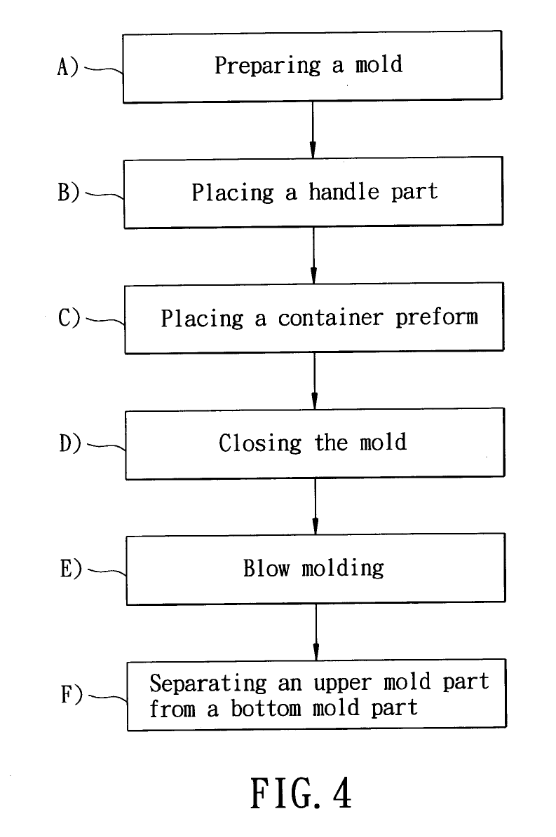

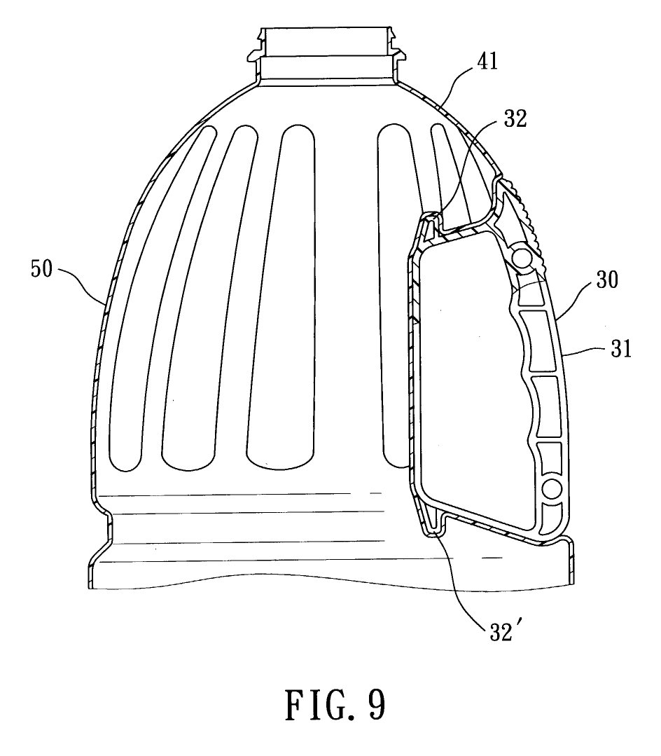

Referring to FIGS. 4 and 9, the preferred embodiment of the method for blow molding a container 50 having a container body 41 and a handle part 30 according to this invention includes the steps of:

A) Preparing a Mold:

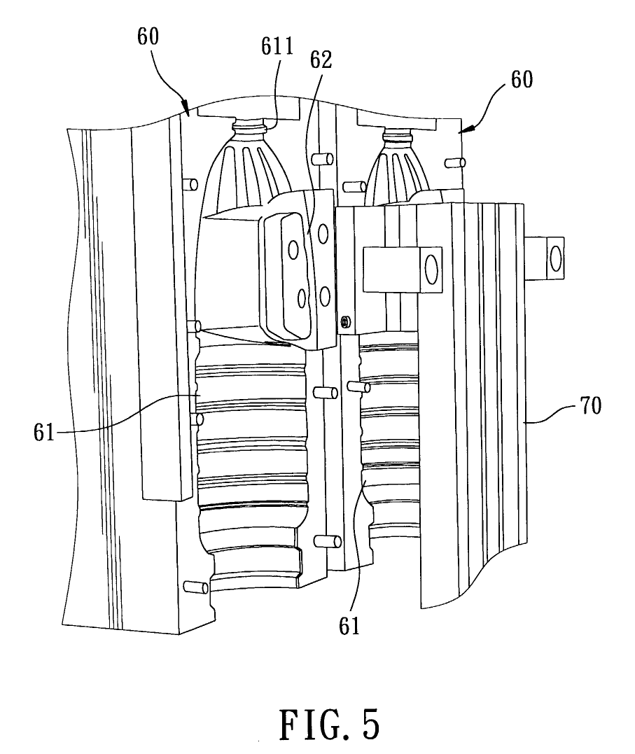

Referring to FIG. 5, a mold is prepared, which includes a bottom mold part 60 having two bottom cavities 61 and two receiving spaces 62, and an upper mold part (not shown) having two upper cavities corresponding to the bottom cavities 61 of the bottom mold part 60, respectively.

B) Placing a Handle Part:

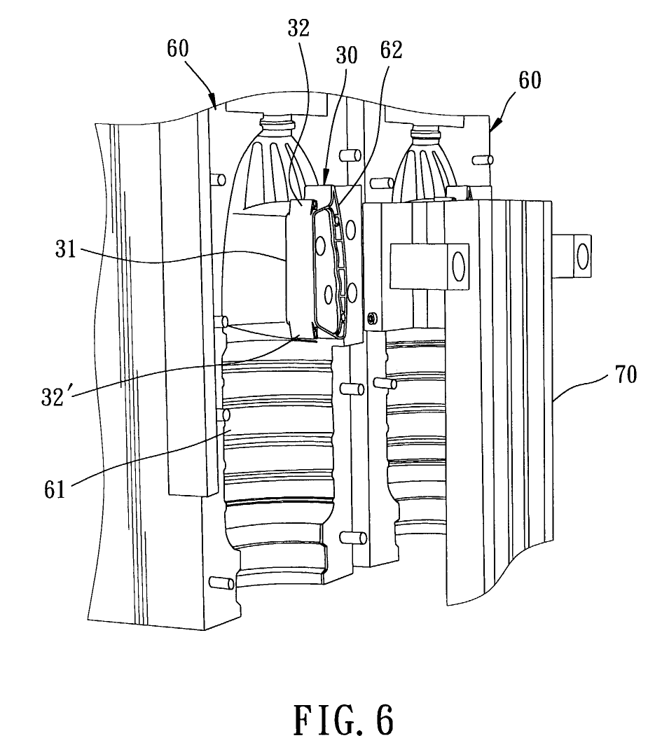

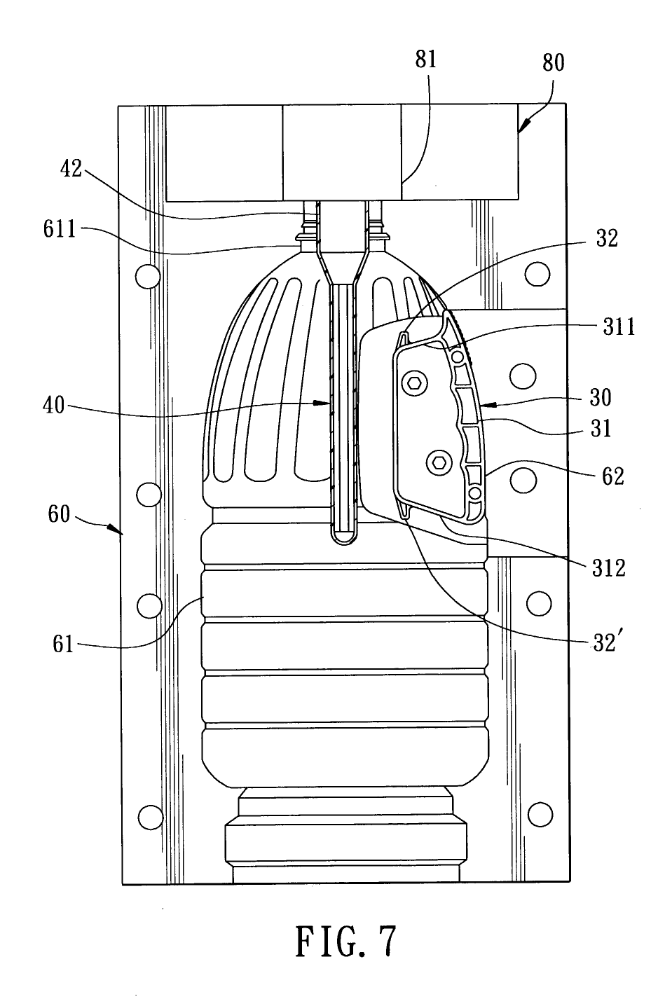

Referring to FIG. 6, two handle parts 30 are placed into the receiving spaces 62 of the bottom mold part 60, respectively. In practice, the handle parts 30 can be placed into the receiving spaces 62 simultaneously by a robot 70 so as to enhance production efficiency. The handle parts 30 can be prepared in advance, or can be commercially available. Referring to FIGS. 6 and 7, each of the handle parts 30 includes a handle body 31, an upper flange 32, and a lower flange 32′. The upper and lower flanges 32, 32′ are distal from each other, protrude from upper and lower portions 311, 312 of the handle body 31 respectively, and extend into the bottom cavity 61 of the bottom mold part 60 when the handle part 30 is placed into the receiving space 62 of the bottom mold part 60.

C) Placing a Container Preform:

Referring again to FIG. 7, a container preform 40 is placed into each of the bottom cavities 61 of the bottom mold part 60. Each of the bottom cavities 61 has a neck cavity 611. The container preform 40 has an opening 42 extending outside the neck cavity 611.

D) Closing the Mold:

The bottom mold part 60 is closed by the upper mold part (not shown) so that each of the upper cavities of the upper mold part cooperates with one of the bottom cavities 61 of the bottom mold part 60 to define a mold cavity for blow molding the container body 41.

E) Blow Molding:

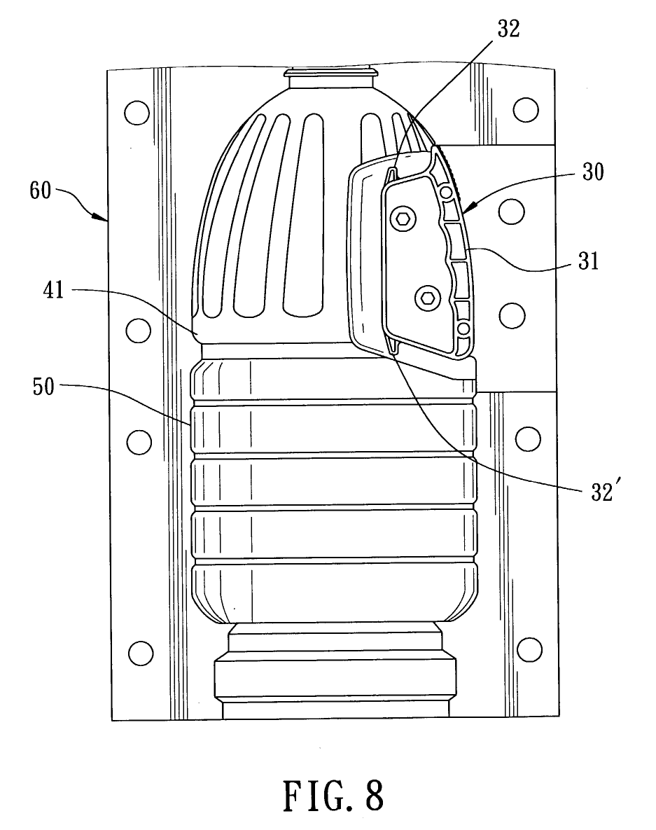

Referring to FIGS. 7 and 8, a blowing mechanism 80 having a blowing nozzle 81 is disposed above the mold so as to connect the blowing nozzle 81 to the opening 42 of the container preform 40. The container preform 40 is then blow molded into the container body 41 by the blowing mechanism 80 in a manner to integrate the container body 41 with the handle part 30 to result in the container 50.

F) Separating the Upper Mold Part From the Bottom Mold Part 60:

The upper mold part is separated from the bottom mold part so as to remove the container 50-from the bottom mold part 60.

In view of the foregoing, since the present method only involves a single blow molding step, rather than two separate molding steps as disclosed in the prior art, the aforesaid shortcomings of the prior art can be overcome.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for blow molding a container having a container body and a handle part, comprising the steps of:
preparing a mold that includes a bottom mold part having a bottom cavity and a receiving space adapted for receiving the handle part, and an upper mold part having an upper cavity corresponding to said bottom cavity of said bottom mold part;
placing the handle part into said receiving space of said bottom mold part of said mold;
placing a container preform into said bottom cavity of said bottom mold part of said mold;
through said upper mold part, closing said bottom mold part so that said upper cavity of said upper mold part cooperates with said bottom cavity of said bottom mold part to define a mold cavity for blow molding said container body; and
blow molding said container preform into said container body in a manner to integrate said container body with the handle part to result in said container.

2. The method as claimed in claim 1, further comprising the step of separating said upper mold part from said bottom mold part so as to remove said container from said bottom mold part.

3. The method as claimed in claim 1, wherein the handle part includes an upper flange and a lower flange which are distal from each other, and which extend into said bottom cavity of said bottom mold part when the handle part is placed into said receiving space of said bottom mold part.
